(19) United States
(12) Patent Application Publication
(10) Pub. No.: US 2022/0360029 A1
(43) Pub. Date: Nov. 10, 2022

(54) PLUG ADAPTER

(71) Applicant: Zhifu Huang, Changsha (CN)

(72) Inventor: Zhifu Huang, Changsha (CN)

(21) Appl. No.: 17/389,366

(22) Filed: Jul. 30, 2021

(30) Foreign Application Priority Data
May 6, 2021 (CN) 202120951503.2

(51) Int. Cl. H01R 24/68; H01R 13/66; H01R 31/06; H01R 13/40; H01R 13/502; H01R 24/30

(52) U.S. Cl. CPC H01R 24/68; H01R 13/665; H01R 31/06; H01R 13/40; H01R 13/502; H01R 24/30; H01R 2103/00

(57) ABSTRACT

A plug adapter includes a housing, a conductive terminal assembly and a phase detection module. The conductive terminal assembly and the phase detection module are installed in the housing. The conductive terminal assembly includes a live conductive member, a neutral conductive member, and an earth conductive member. The live conductive member is integrally formed with a live conductive socket and a live conductive pin. The neutral conductive member is integrally formed with a neutral conductive socket and a neutral conductive pin. The earth conductive member is integrally formed with an earth conductive socket and an earth conductive pin. The plug adapter is not easy to burn out due to overheating.

### BACKGROUND OF THE INVENTION

### 1. Field of the Invention

The present invention relates to a plug adapter, and more particularly to a plug adapter having integrated terminals.

### 2. Description of the Prior Art

In order to improve the safety of electricity use, a safety plug adapter having a phase detection function is developed on the market. The safety plug adapter can detect the status of the live wire, the neutral wire and the earth wire to improve the safety of electricity use. In the prior art, such a plug adapter includes a housing, a female terminal assembly, a male terminal assembly, and a phase detection module. The top of the housing has a live slot, a neutral slot, and an earth slot. The bottom of the housing has a live perforation, a neutral perforation, and an earth perforation. The female terminal assembly includes three conductive sockets installed in the housing. The three conductive sockets are defined as a live conductive socket, a neutral conductive socket and an earth conductive socket. The live conductive socket, the neutral conductive socket and the earth conductive socket are aligned with the live slot, the neutral slot and the earth slot, respectively. The male terminal assembly includes three conductive pins. The three conductive pins are defined as a live conductive pin, a neutral conductive pin and an earth conductive pin. The live conductive pin, the neutral conductive pin and the earth conductive pin are aligned with the live perforation, the neutral perforation and the earth perforation, respectively.

The live conductive pin, the neutral conductive pin and the earth conductive pin are connected to the live conductive socket, the neutral conductive socket and the earth conductive socket through wires, respectively. The phase detection module is electrically connected to the female terminal assembly and the male terminal assembly.

The conventional safety plug adapter has the following problems:

The three conductive pins of the conventional safety plug adapter are connected to the three conductive sockets through wires, respectively. The wires are connected to the conductive pins and the conductive sockets by welding, which is more troublesome in assembly. In addition, if the welding is not good, it is easy to cause excessive contact resistance between the wires and the conductive pins as well as the conductive sockets. This will cause the welding area to heat up easily to burn the safety plug adapter because of overheating. In addition, the welding area of the wire is likely to loosen due to external vibration, which in turn causes the welding areas of the wires, the conductive pins and the conductive sockets to heat up. As a result, the safety plug adapter is easily overheated and burned.

### SUMMARY OF THE INVENTION

The primary object of the present invention is to provide a plug adapter to overcome the shortcomings of the prior art.

In order to achieve the above object, the present invention adopts the following solutions.

A plug adapter comprises a housing, a conductive terminal assembly, and a phase detection module. A top of the housing has a live slot, a neutral slot, and an earth slot. A bottom of the housing has a live perforation, a neutral perforation, and an earth perforation. The conductive terminal assembly includes a live conductive member, a neutral conductive member, and an earth conductive member. Upper and lower portions of the live conductive member are integrally formed with a live conductive socket and a live conductive pin, respectively. Upper and lower portions of the neutral conductive member are integrally formed with a neutral conductive socket and a neutral conductive pin, respectively. Upper and lower portions of the earth conductive member are integrally formed with an earth conductive socket and an earth conductive pin, respectively. The live conductive socket, the neutral conductive socket and the earth conductive socket are disposed in the housing. The live conductive socket, the neutral conductive socket and the earth conductive socket are aligned with the live slot, the neutral slot and the earth slot, respectively. The live conductive pin, the neutral conductive pin and the earth conductive pin pass through the live perforation, the neutral perforation and the earth perforation, respectively. The phase detection module is installed in the housing. The phase detection module is electrically connected to the live conductive member, the neutral conductive member and the earth conductive member.

Preferably, the housing includes an upper housing and a lower housing connected to each other. The upper housing is formed with the live slot, the neutral slot and the earth slot. The lower housing is formed with the live perforation, the neutral perforation and the earth perforation.

Preferably, the lower housing is locked to the upper housing by a fixing screw.

Preferably, the plug adapter further comprises an insulating mounting seat. The insulating mounting seat is installed in the housing. The insulating mounting seat has three mounting grooves. The live conductive member, the neutral conductive member and the earth conductive member are connected to the three mounting grooves of the insulating mounting seat, respectively.

Preferably, the insulating mounting seat is locked to the housing by a mounting screw.

Preferably, the phase detection module includes a phase detection unit and a phase indication unit that are separately arranged. The phase detection unit is electrically connected to the live conductive member, the neutral conductive member and the earth conductive member. The phase indication unit is electrically connected to the phase detection unit. The phase indication unit includes a live indicator, a neutral indicator and an earth indicator. The top of the housing has a live indicator hole, a neutral indicator hole and an earth indicator hole corresponding to the live indicator, the neutral indicator and the earth indicator, respectively.

Preferably, the live indicator, the neutral indicator and the earth indicator of the phase indication unit are inserted into the live indicator hole, the neutral indicator hole and the earth indicator hole of the housing, respectively.

Preferably, the phase indication unit is locked to the housing by a connecting screw.

Preferably, a fastener is provided in the housing for fastening the phase detection unit.

Preferably, the live conductive member, the neutral conductive member and the earth conductive member are integrally formed with a live male terminal, a neutral male terminal and an earth male terminal, respectively, for connecting the phase detection module. The live male terminal, the neutral male terminal and the earth male terminal are connected to the phase detection module through a detection wire. The detection wire is provided with three detection female terminals for connecting the live male terminal, the neutral male terminal and the earth male terminal, respectively.

With the above solutions, the present invention has the following features.

1. In the present invention, the upper and lower portions of the live conductive member are integrally formed with the live conductive socket and the live conductive pin, respectively; the upper and lower portions of the neutral conductive member are integrally formed with the neutral conductive socket and the neutral conductive pin, respectively; the upper and lower portions of the earth conductive member are integrally formed with the earth conductive socket and the earth conductive pin, respectively; that is, the live conductive socket and the live conductive pin of the live conductive member are integrally formed; the neutral conductive socket and the neutral conductive pin of the neutral conductive member are integrally formed; the earth conductive socket and the earth conductive pin of the earth conductive member are integrated formed. With such an arrangement, the live conductive socket and the live conductive pin of the present invention are finely connected to each other and there is no contact resistance between them; the neutral conductive socket and the neutral conductive pin are firmly connected to each other and there is no contact resistance between them; the earth conductive socket and the earth conductive pin are firmly connected to each other and there is no contact resistance between them. In this way, the present invention can effectively reduce the heating caused by loose connection and excessive contact resistance, thereby avoiding burning because of overheating.

2. In the present invention, the live conductive socket and the live conductive pin of the live conductive member are integrally formed; the neutral conductive socket and the neutral conductive pin of the neutral conductive member are integrally formed; the earth conductive socket and the earth conductive pin of the earth conductive member are integrated formed, such that the present invention can reduce the assembly process and improve the assembly efficiency compared with the prior art.

3. In the present invention, the live conductive member, the neutral conductive member and the earth conductive member are integrally formed with the live male terminal, the neutral male terminal and the earth male terminal, respectively, for connecting the phase detection unit of the phase detection module. The live male terminal, the neutral male terminal and the earth male terminal are connected to the phase detection unit of the phase detection module through a detection wire. The detection wire is provided with three detection female terminals for connecting the live male terminal, the neutral male terminal and the earth male terminal, respectively. The live conductive member, the neutral conductive member and the earth conductive member are connected to the detection wire by plugging, so that the connection between the live conductive member, the neutral conductive member and the earth conductive member and the detection wire is more convenient.

### BRIEF DESCRIPTION OF THE DRAWINGS

FIG. 1 is a first perspective view of the present invention;

FIG. 2 is a second perspective view of the present invention;

FIG. 3 is a schematic view of a partial structure of the present invention;

FIG. 4 is a first exploded view of the present invention;

FIG. 5 is a second exploded view of the present invention;

FIG. 6 is a first cross-sectional view of the present invention;

FIG. 7 is a second cross-sectional view of the present invention;

FIG. 8 is a third cross-sectional view of the present invention; and

FIG. 9 is a fourth cross-sectional view of the present invention.

### DETAILED DESCRIPTION OF THE PREFERRED EMBODIMENTS

Embodiments of the present invention will now be described, by way of example only, with reference to the accompanying drawings.

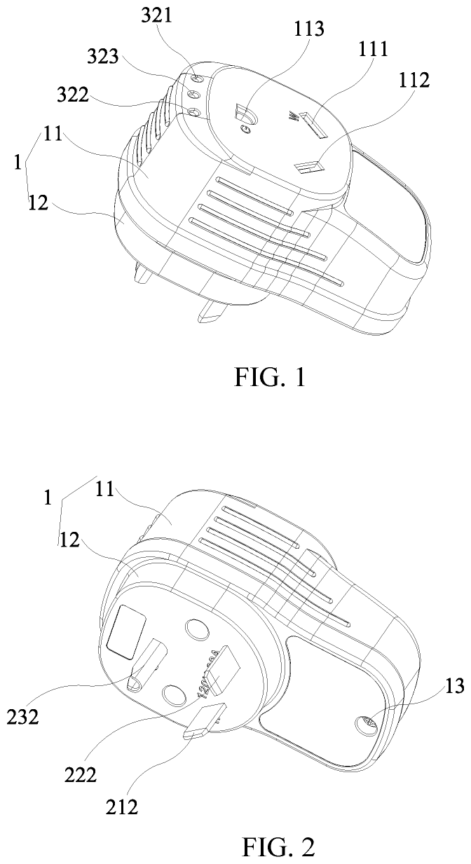

As shown in FIGS. 1-9, the present invention discloses a plug adapter, comprising a housing 1, a conductive terminal assembly 2, and a phase detection module 3. The top of the housing 1 has a live slot 111, a neutral slot 112 and an earth slot 113. The bottom of the housing 1 has a live perforation 121, a neutral perforation 122 and an earth perforation 123. The conductive terminal assembly 2 includes a live conductive member 21, a neutral conductive member 22 and an earth conductive member 23. The upper and lower portions of the live conductive member 21 are integrally formed with a live conductive socket 211 and a live conductive pin 212, respectively. The upper and lower portions of the neutral conductive member 22 are integrally formed with a neutral conductive socket 221 and a neutral conductive pin 222, respectively. The upper and lower portions of the earth conductive member 23 are integrally formed with an earth conductive socket 231 and an earth conductive pin 232, respectively. The live conductive socket 211, the neutral conductive socket 221 and the earth conductive socket 231 are disposed in the housing 1. The live conductive socket 211, the neutral conductive socket 221 and the earth conductive socket 231 are aligned with the live slot 111, the neutral slot 112 and the earth slot 113, respectively. The live conductive pin 212, the neutral conductive pin 222 and the earth conductive pin 232 pass through the live perforation 121, the neutral perforation 122 and the earth perforation 123, respectively. The phase detection module 3 is installed in the housing 1. The phase detection module 3 is electrically connected to the live conductive member 21, the neutral conductive member 22 and the earth conductive member 23.

In the present invention, the upper and lower portions of the live conductive member 21 are integrally formed with the live conductive socket 211 and the live conductive pin 212, respectively; the upper and lower portions of the neutral conductive member 22 are integrally formed with the neutral conductive socket 221 and the neutral conductive pin 222, respectively; the upper and lower portions of the earth conductive member 23 are integrally formed with the earth conductive socket 231 and the earth conductive pin 232, respectively; that is, the live conductive socket 211 and the live conductive pin 212 of the live conductive member 21 are integrally formed; the neutral conductive socket 221 and the neutral conductive pin 222 of the neutral conductive member 22 are integrally formed; the earth conductive socket 231 and the earth conductive pin 232 of the earth conductive member 23 are integrated formed. With such an arrangement, the live conductive socket 211 and the live conductive pin 212 of the present invention are firmly connected to each other and there is no contact resistance between them; the neutral conductive socket 221 and the neutral conductive pin 222 are firmly connected to each other and there is no contact resistance between them; the earth conductive socket 231 and the earth conductive pin 232 are firmly connected to each other and there is no contact resistance between them. In this way, the present invention can effectively reduce the heating caused by loose connection and excessive contact resistance, thereby avoiding burning because of overheating. In addition, the live conductive socket 211 and the live conductive pin 212 of the live conductive member 21 are integrally formed; the neutral conductive socket 221 and the neutral conductive pin 222 of the neutral conductive member 22 are integrally formed; the earth conductive socket 231 and the earth conductive pin 232 of the earth conductive member 23 are integrated formed. Compared with the prior art, the present invention can reduce the assembly process and improve the assembly efficiency.

As shown in FIGS. 1-9, the housing 1 may include an upper housing 11 and a lower housing 12 connected to each other. The upper housing 11 is formed with the live slot 111, the neutral slot 112 and the earth slot 113. The lower housing 12 is formed with the live perforation 121, the neutral perforation 122 and the earth perforation 123. The lower housing 12 is locked to the upper housing 11 by fixing screws 13, so that the upper housing 11 and the lower housing 12 of the housing 1 are easily assembled, thereby improving the assembling efficiency of the present invention.

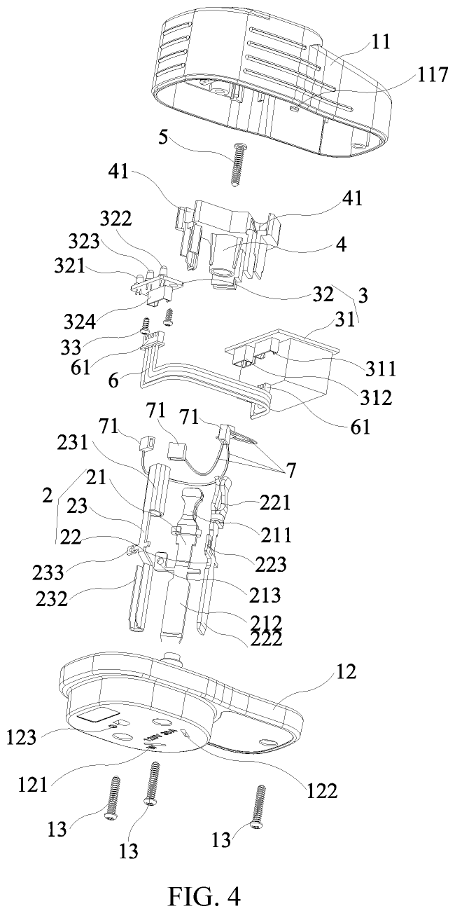

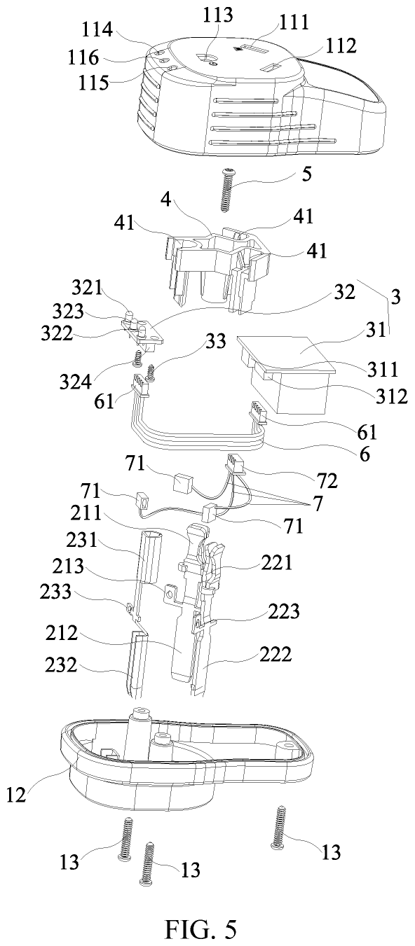

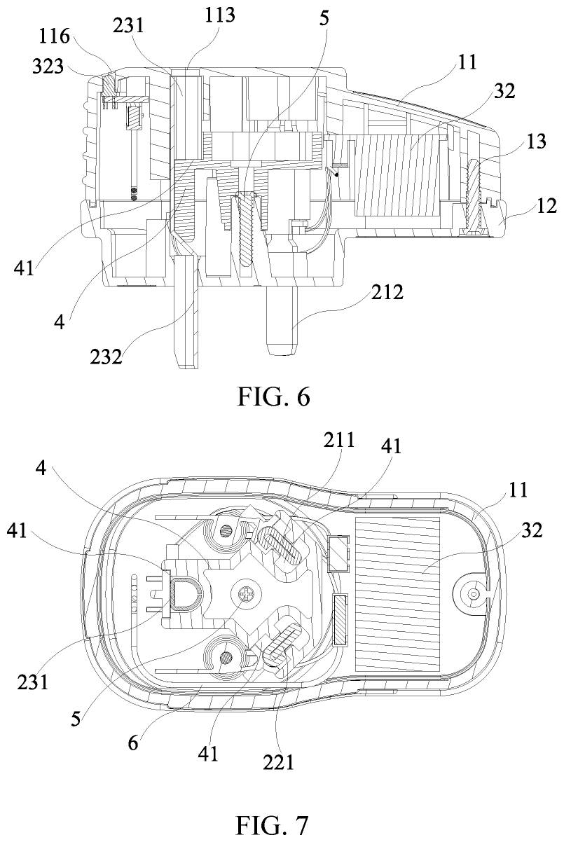

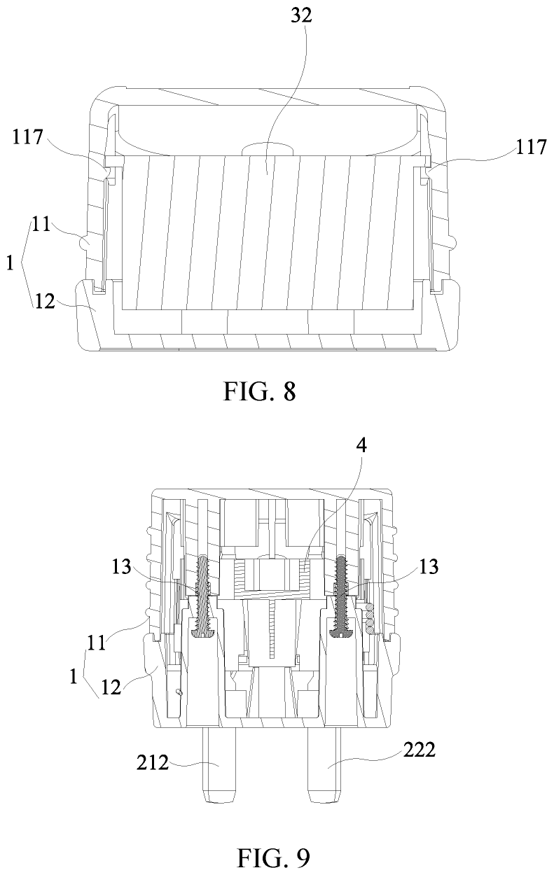

As shown in FIGS. 4 to 6, the phase detection module 3 may include a phase detection unit 31 and a phase indication unit 32 that are separately arranged. The phase detection unit 31 is electrically connected to the live conductive member 21, the neutral conductive member 22 and the earth conductive member 23. The phase indication unit 32 is electrically connected to the phase detection unit 31. The phase indication unit 32 includes a live indicator 321, a neutral indicator 322, and an earth indicator 323. The top of the housing 1 has a live indicator hole 114, a neutral indicator hole 115 and an earth indicator hole 116 corresponding to the live indicator 321, the neutral indicator 322 and the earth indicator 323, respectively, so that the user can see the respective working states of the live indicator 321, the neutral indicator 322, and the earth indicator 323. The live indicator hole 114, the neutral indicator hole 115 and the earth indicator hole 116 are disposed on the upper housing of the housing 1. As shown in FIG. 1, FIG. 4, FIG. 5, FIG. 6 and FIG. 8, the phase indication unit 32 of the phase detection module 3 is locked to the upper housing 11 of the housing 1 by a connecting screw 33, so as to fix the phase indication unit 32. The live indicator 321, the neutral indicator 322 and the earth indicator 323 of the phase indication unit 32 are respectively inserted into the live indicator hole 114, the neutral indicator hole 115 and the earth indicator hole 116 of the housing 1, so that the phase indication unit 32 can be accurately installed. A fastener 117 is provided in the housing 1 for fastening the phase detection unit 31. The fastener 117 is disposed on the upper housing 11 of the housing 1. As shown in FIGS. 2 to 4, the phase detection unit 31 and the phase indication unit 32 are connected by a connecting wire 6. Two ends of the connecting wire 6 are provided with connecting male terminals 61. The phase detection unit 31 is provided with a first female terminal 311. The phase indication unit 32 is provided with a connecting female terminal 324. The connecting male terminals 61 at both ends of the connecting wire 6 are insertedly connected to the first female terminal 311 and the connecting female terminal 324, respectively. In the present invention, the phase detection unit 31 of the phase detection module 3 is configured to detect the energization state of the live conductive member 21, the neutral conductive member 22 and the earth conductive member 23. The phase indication unit 32 is configured to display the energization state of the live conductive member 21, the neutral conductive member 22 and the earth conductive member 23. The specific circuit of the phase detection unit 31 and the phase indication unit 32 of the phase detection module 3 is the prior art, and will not be further described hereinafter. It should be noted that the phase detection unit 31 and the phase indication unit 32 of the present invention are not limited to separate settings. The phase detection unit 31 and the phase indication unit 32 may be integrated. In this way, the phase detection module 3 can also detect and indicate the energization state of the live conductive member 21, the neutral conductive member 22 and the earth conductive member 23. In the present invention, the phase detection unit 31 and the phase indication unit 32 are arranged separately to facilitate the adjustment of the component installation layout, so that the present invention has a compact structure.

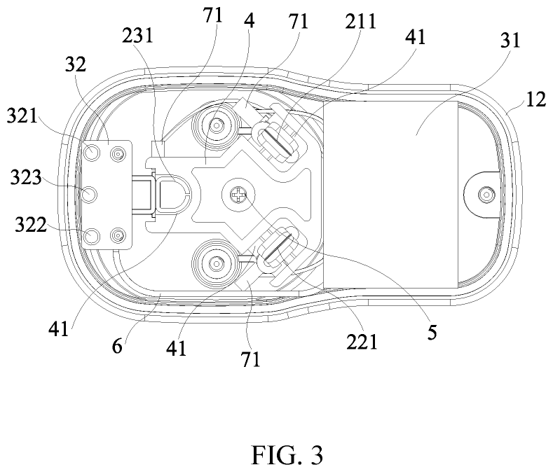

As shown in FIGS. 3 to 7, the plug adapter of the present invention further comprises an insulating mounting seat 4 for fixing the conductive terminal assembly 2. The insulating mounting seat 4 is installed in the housing 1. The insulating mounting seat 4 has three mounting grooves 41. The live conductive member 21, the neutral conductive member 22 and the earth conductive member 23 are connected to the three mounting grooves 41 of the insulating mounting seat 4 respectively, so as to fix the conductive terminal assembly 2. The live conductive member 21, the neutral conductive member 22 and the earth conductive member 23 of the conductive terminal assembly 2 are connected to the insulating mounting seat 4 by a snap-fit connection. The connection is simple and easy to operate. As shown in FIG. 6, the insulating mounting seat 4 is locked to the housing 1 through a mounting screw 5, so as to fix the insulating mounting seat 4.

In the present invention, as shown in FIGS. 2 to 4, the live conductive member 21, the neutral conductive member 22 and the earth conductive member 23 are integrally formed with a live male terminal 213, a neutral male terminal 223 and an earth male terminal 233, respectively, for connecting the phase detection unit 31 of the phase detection module 3. The live male terminal 213, the neutral male terminal 223 and the earth male terminal 233 are connected to the phase detection unit 31 of the phase detection module 3 through a detection wire 7. The detection wire 7 is provided with three detection female terminals 71 for connecting the live male terminal 213, the neutral male terminal 223 and the earth male terminal 233, respectively. The live conductive member 21, the neutral conductive member 22 and the earth conductive member 23 are connected to the detection wire 7 by plugging, so that the connection between the live conductive member 21, the neutral conductive member 22 and the earth conductive member 23 and the detection wire 7 is more convenient. In addition, in the present invention, the live conductive member 21, the neutral conductive member 22 and the earth conductive member 23 are integrally formed with the live male terminal 213, the neutral male terminal 223 and the earth male terminal 233 respectively, so that the live conductive member 21, the neutral conductive member 22 and the earth conductive member 23 are more easily provided with the live male terminal 213, the neutral male terminal 223 and the earth male terminal 233, respectively. The phase detection unit 31 of the phase detection module 3 may be provided with a second female terminal 312 for connecting the detection wire 7. The detection wire 7 is provided with a detection male terminal 72 to be inserted into the second female terminal 312. The detection wire 7 is plugged and matched with the phase detection unit 31 of the phase detection module 3, so that the connection between the detection wire 7 and the phase detection module 3 is simpler and more convenient.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A plug adapter, comprising a housing, a conductive terminal assembly, and a phase detection module;
a top of the housing having a live slot, a neutral slot and an earth slot, a bottom of the housing having a live perforation, a neutral perforation and an earth perforation;
the conductive terminal assembly including a live conductive member, a neutral conductive member and an earth conductive member, upper and lower portions of the live conductive member being integrally formed with a live conductive socket and a live conductive pin respectively, upper and lower portions of the neutral conductive member being integrally formed with a neutral conductive socket and a neutral conductive pin respectively, upper and lower portions of the earth conductive member being integrally formed with an earth conductive socket and an earth conductive pin respectively; the live conductive socket, the neutral conductive socket and the earth conductive socket being disposed in the housing, the live conductive socket, the neutral conductive socket and the earth conductive socket being aligned with the live slot, the neutral slot and the earth slot respectively; the live conductive pin, the neutral conductive pin and the earth conductive pin passing through the live perforation, the neutral perforation and the earth perforation, respectively;
the phase detection module being installed in the housing, the phase detection module being electrically connected to the live conductive member, the neutral conductive member and the earth conductive member.

2. The plug adapter as claimed in claim 1, wherein the housing includes an upper housing and a lower housing connected to each other; the upper housing is formed with the live slot, the neutral slot and the earth slot; the lower housing is formed with the live perforation, the neutral perforation and the earth perforation.

3. The plug adapter as claimed in claim 2, wherein the lower housing is locked to the upper housing by a fixing screw.

4. The plug adapter as claimed in claim 1, further comprising an insulating mounting seat, the insulating mounting seat being installed in the housing, the insulating mounting seat having three mounting grooves, the live conductive member, the neutral conductive member and the earth conductive member being connected to the three mounting grooves of the insulating mounting seat, respectively.

5. The plug adapter as claimed in claim 4, wherein the insulating mounting seat is locked to the housing by a mounting screw.

6. The plug adapter as claimed in claim 1, wherein the phase detection module includes a phase detection unit and a phase indication unit that are separately arranged, the phase detection unit is electrically connected to the live conductive member, the neutral conductive member and the earth conductive member, the phase indication unit is electrically connected to the phase detection unit, the phase indication unit includes a live indicator, a neutral indicator and an earth indicator, and the top of the housing has a live indicator hole, a neutral indicator hole and an earth indicator hole corresponding to the live indicator, the neutral indicator and the earth indicator, respectively.

7. The plug adapter as claimed in claim 6, wherein the live indicator, the neutral indicator and the earth indicator of the phase indication unit are inserted into the live indicator hole, the neutral indicator hole and the earth indicator hole of the housing, respectively.

8. The plug adapter as claimed in claim 6, wherein the phase indication unit is locked to the housing by a connecting screw.

9. The plug adapter as claimed in claim 6, wherein a fastener is provided in the housing for fastening the phase detection unit.

10. The plug adapter as claimed in claim 6, wherein the live conductive member, the neutral conductive member and the earth conductive member are integrally formed with a live male terminal, a neutral male terminal and an earth male terminal, respectively, for connecting the phase detection module, the live male terminal, the neutral male terminal and the earth male terminal are connected to the phase detection module through a detection wire, and the detection wire is provided with three detection female terminals for connecting the live male terminal, the neutral male terminal and the earth male terminal, respectively.

11. The plug adapter as claimed in claim 1, wherein the live conductive member, the neutral conductive member and the earth conductive member are integrally formed with a live male terminal, a neutral male terminal and an earth male terminal, respectively, for connecting the phase detection module, the live male terminal, the neutral male terminal and the earth male terminal are connected to the phase detection module through a detection wire, and the detection wire is provided with three detection female terminals for connecting the live male terminal, the neutral male terminal and the earth male terminal, respectively.
